(19) United States
(12) Patent Application Publication
(10) Pub. No.: US 2014/0310176 A1
(43) Pub. Date: Oct. 16, 2014

(54) ANALYTICS RULES ENGINE FOR PAYMENT PROCESSING SYSTEM

(71) Applicant: MasterCard International Incorporated, Purchase, NY (US)

(72) Inventors: Greg Saunders, O'Fallon, MO (US); Thenuis Johannes Gerber, Wildwood, MO (US); Mark Wiesman, Chesterfield, MO (US)

(73) Assignee: MasterCard International Incorporated, Purchase, NY (US)

(21) Appl. No.: 14/252,254

(22) Filed: Apr. 14, 2014

Related U.S. Application Data
(60) Provisional application No. 61/811,666, filed on Apr. 12, 2013.

(51) Int. Cl. G06Q 20/40

(52) U.S. Cl. CPC G06Q 20/405
USPC 705/44

(57) ABSTRACT

According to some embodiments, a payment system authorization platform may receive an authorization message from an acquirer platform. The payment system authorization platform may determine that the authorization request meets a pre-determined condition and transmit information about the authorization message to an analytics rules engine, such as by transmitting the authorization message. The analytics rules engine may analyze the information about the authorization message in accordance with at least one rule to generate a result and transmit information about the authorization message to the payment system authorization platform, such as by transmitting a supplemented authorization message or an authorization approval decision.

### CROSS-REFERENCE TO RELATED APPLICATIONS

The present application claims the benefit of U.S. Provisional Patent Application No. 61/811,666 entitled “ANALYTICS RULES ENGINE FOR PAYMENT PROCESSING SYSTEM” and filed Apr. 12, 2013. The entire content of that application is incorporated herein by reference.

Applicants further note: (1) U.S. Pat. No. 8,126,791 for a Methods and Systems for Providing a Decision Making Platform (directed to the decision making platform) and (2) U.S. patent application Ser. No. 13/748,939 for AUTOMATED TELLER MACHINE TRANSACTION BLOCKING filed on Jan. 24, 2013 (directed to a service specific to ATMs). The entire contents of both of those documents are incorporated herein by reference.

### FIELD OF THE INVENTION

Embodiments disclosed herein relate to methods, apparatus and systems that include an analytics rules engine that facilitates the processing of payment card transactions.

### BACKGROUND

Payment card systems are in widespread use. A prominent payment card system is operated by the assignee hereof, MasterCard International Incorporated, and by its member financial institutions. FIG. 1 schematically illustrates a typical transaction, as carried out by using a conventional payment system 100. To initiate the transaction, a customer may visit a retail store operated by a merchant, selects goods that he/she wishes to purchase, and presents his/her payment card to a merchant's Point Of Sale (“POS”) terminal. The POS terminal reads the customer's payment card account number from the payment card, and then sends an authorization request to an acquirer platform 110 associated with a financial institution with which the merchant has a relationship. The authorization request typically includes the payment card account number, the amount of the transaction and other information, such as merchant identification and location. The authorization request message is routed via a payment system authorization platform 120 (which may be, for example, the well-known Banknet™ system operated by MasterCard International Incorporated) to an issuer platform 130 of the issuer financial institution that issued the customer's payment card.

Assuming that all is in order, the issuer platform 130 transmits a favorable authorization response to the acquirer platform 110 through the payment system authorization platform 120. The transaction at the POS is then completed and the customer leaves the store with the goods. A subsequent clearing transaction initiated by the merchant results in a transfer of the transaction amount from the customer's payment card account to an account that belongs to the merchant. The customer's payment card account may be, for example, either a debit card account or a credit card account. In the former case, the clearing transaction results in the funds being debited directly from the account. In the latter case, the clearing transaction results in a charge being posted against the account, and the charge subsequently appears on the customer's monthly credit card statement.

The foregoing description of the typical transaction may be considered to be somewhat simplified in some respects. For example, a merchant processing system (not shown) may be interposed between the POS terminal and the acquirer platform 110. As is familiar to those who are skilled in the art, a merchant processing system may be operated by or on behalf of the merchant to form part of the communications path between the acquirer platform 110 and a considerable number of POS terminals operated by the merchant. It is also often the case that a third party transaction processing service, such as a Payment Services Provider (“PSP”), may operate to handle payment card transactions on behalf of the acquirer and on behalf of a large number of other like financial institutions.

In addition to POS transactions, the acquirer platform 110 may process transactions associated with Automated Teller Machine (“ATM”) withdrawals and Card Not Present (“CNP”) online transactions in a similar manner.

The payment cardholder, acquirer and issuer financial institutions, and payment system authorization platforms all have an interest in reducing fraudulent transactions. Moreover, it is desirable to reduce fraudulent transactions without declining transactions that are, in fact, not fraudulent.

The present inventors have recognized that there is a need for methods and/or systems to provide an analytics rules engine to facilitate the processing of payment card transactions.

### BRIEF DESCRIPTION OF THE DRAWINGS

FIG. 1 illustrates a typical payment card system.

FIG. 2 is a block diagram view of a system in accordance with some embodiments.

FIG. 3 is a payment system authorization method that may be performed in accordance with some embodiments.

FIG. 4 is an analytics rules engine method that may be performed in accordance with some embodiments.

FIGS. 5, 6A, and 6B illustrate transaction flows according to some embodiments.

FIG. 7 represents an analytics rules engine in accordance with some embodiments.

FIG. 8 is a payment system authorization platform that may be provided in accordance with some embodiments.

FIG. 9 is a payment system authorization database that may be provided in accordance with some embodiments.

FIG. 10 is an analytics rules engine that may be provided in accordance with some embodiments.

FIG. 11 is an analytics rules engine database that may be provided in accordance with some embodiments.

FIG. 12 is a high level block diagram of a decision management profiling system according to some embodiments.

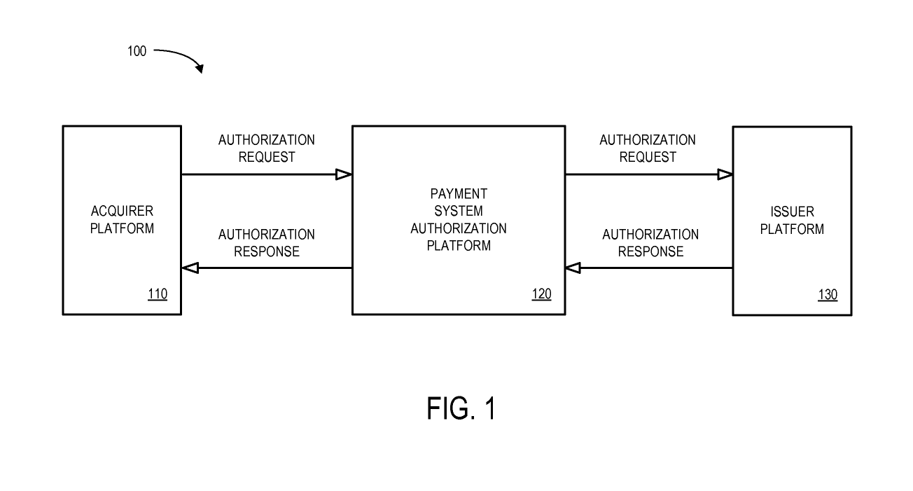

### DETAILED DESCRIPTION

In general, and for the purpose of introducing concepts of embodiments of the present invention, a “payment card” may be used to process transactions. As used herein, the phrase “payment card” might refer to, for example, a credit card, a debit card, a loyalty program card, a badge, a license, a passport card, a radio frequency apparatus, a smartphone, and/or a contactless card.

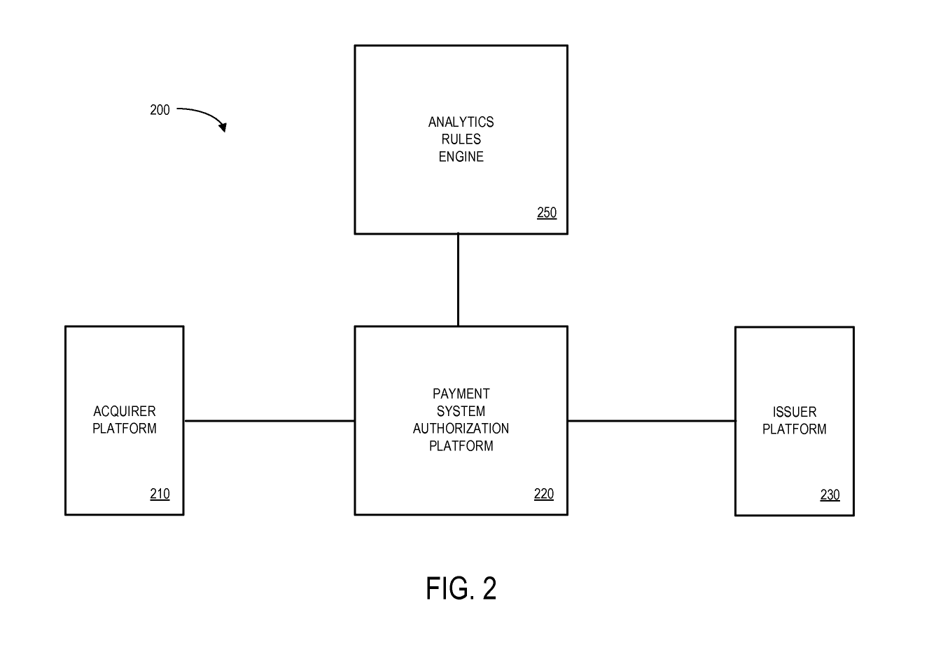

FIG. 2 is a block diagram of a transaction handling system 200 including components configured to operate in accordance with aspects of the processes described herein. It should be understood that the various components shown in FIG. 2 may be a subset of a larger system for providing payment card recommendations to consumers and for facilitating purchase transactions between consumers and merchants via credit card accounts, debit card accounts, reward card accounts, other types of financial accounts and the like, and/or for facilitating payment transactions between one or more financial institutions such as acquirer and issuer banks.

As before, an acquirement platform 210 may request authorization of a payment card transaction from an issuer platform 230 via a payment authorization platform 220. To reduce fraudulent transactions, the payment system authorization platform 220 may exchange information with an analytics rules engine 250 in accordance with any of the embodiments described herein.

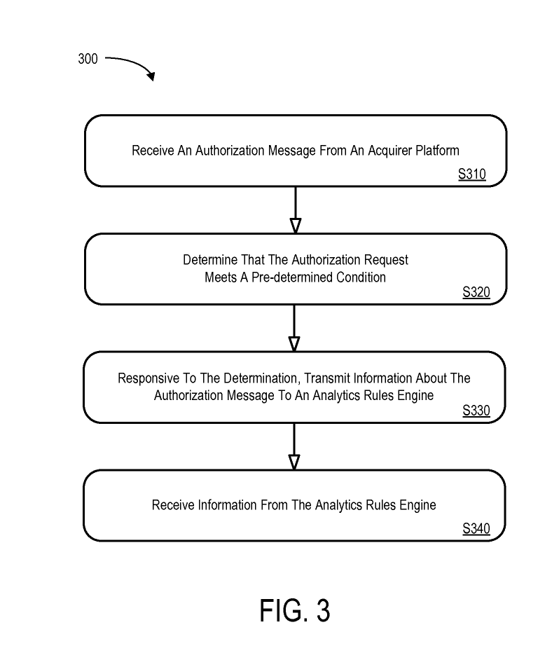

For example, FIG. 3 illustrates a method 300 that might be performed by payment system authorization platform 220 of the system 200 described with respect to FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein. Further note that some or all of the steps may be “automated.” As used herein, the term “automated” may refer to, for example, actions that can be performed with little or no human intervention.

At S310, the payment system authorization platform may receive an authorization message from an acquirer platform. At S320 the payment system authorization platform may determine that the authorization request meets a pre-determined condition. The determination might be based on, for example, a Bank Identification Number (“BIN”) and/or 16-digit primary account number associated with the authorization request.

Responsive to the determination, information about the authorization message may be transmitted to an analytics rules engine at S330. The transmitting might comprise, for example, forwarding the authorization message to the analytics rules engine.

At S340, the payment system authorization platform may receive information from the analytics rules engine. The information received from the analytics rules engine might comprise, for example, a supplemented authorization message. According to some embodiments, the supplemented authorization message includes at least one of: (i) a risk flag, (ii) a risk score, (iii) a cardholder category, (iv) a terminal category, and (v) enhanced expert monitoring service score data. Note that enhanced expert monitoring service score data is used herein only as an example and embodiments may provide information in any of a number of different ways. According to some embodiments, the system may supplement an authorization message with a reason code (e.g. alpha-numeric “A1”) which can then be interpreted by the customer (e.g. issuer, merchant) in some predefined manner (e.g. “A1” is a cardholder category for Frequent Traveler). A risk flag, risk score, and EMS score data may all be supplemented into the authorization message. These items might be added by other—services which could consume/reference the reason code to help generate a risk score for example.

The supplemented authorization message may then be forwarded to at least one of: (i) the acquirer platform, and (ii) an issuer platform. For example, the issuer platform might use the supplemental data to decide whether or not the transaction should be approved.

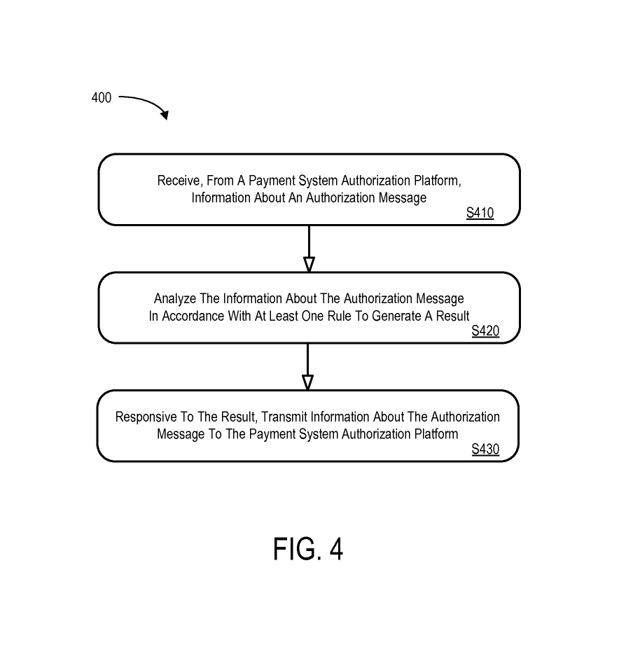

FIG. 4 illustrates an analytics rules engine method 400 that might be performed by the analytics rules engine 250 of the system 200 of FIG. 2 according to some embodiments. At S410, an analytics rules engine may receive, from a payment system authorization platform, information about an authorization message. The received information might comprise, for example, the authorization message. At S420, the analytics rules engine may analyze the information about the authorization message in accordance with at least one rule to generate a result. The rule might be based on, for example, information about at least one of: (i) a cardholder associated with the authorization message, (ii) an account associated with the authorization message, (iii) a payment card associated with the authorization message, (iv) a merchant associated with the authorization message, and (v) a merchant terminal associated with the authorization message.

According to some embodiments, the rule is based on a travel category. For example a cardholder might be classified as an international traveler, an interstate traveler, or someone who never travels. This information can then be used to flag unusual activity (e.g., a card associated with someone who never travels is being used in a distant state or country.

In additional to an extended cardholder view, embodiments might provide an expanded terminal view (e.g., for an ATM). For example, a rule might ask if current ATM activity is normal, whether or not the current ATM transaction fits within this cardholder's historical ATM pattern, how much he or she typically withdraws, how many withdrawals typically occur at that terminal (e.g., per day, per week, or per month), how many withdrawals typically occur by that cardholder (e.g., per day, per week, or per month) the single largest withdrawal by the cardholder, and/or whether the cardholder is traveling. In some case, the rule might be based on whether the cardholder has made any recent transactions with a travel merchant that would indicate he or she may be traveling in the future, how likely is it this is a counterfeit card, whether or not the transaction is typical (for this ATM terminal or holder), whether a particular issuer's cards have been used at that location, cards have not been used this frequently in the past, how much money is typically withdrawn (per hour, day, week, or month), and/or what was the largest amount withdrawn. Note that embodiments may let one view terminal activity across multiple issuers.

According to some embodiments, the rules are based on an online spending category, whether or not the cardholder is a seasonal shopper, an established shopper, or someone who never shops online. Note that embodiments might review cardholder activity over a long enough time period to account for seasonal spending (e.g., Christmas, Valentine's Day, “Cyber Monday”), establish custom spend levels for each segment as well as within each segment, allow one to continually refresh this segmentation at a mutually desired frequency, and/or manage authorization strategies to optimize approvals while balancing fraud risk.

Note that the rules may be based on information about a terminal associated with the authorization message, such as (i) a transaction frequency, (ii) a transaction amount, and/or (iii) a transaction location. Further note that the rules may be based on issuers other than an issuer associated with the authorization message, a cardholder other than a cardholder associated with the authorization message, and/or a terminal other than a terminal associated with the authorization message. Note that that the rule may incorporate information from other issuers in addition to the issuer associated with the authorization message. In some embodiments, the rule(s) will not only be based on the issuer, cardholder, merchant, and terminal associated with the authorization message, but also include information from other issuers, cardholders, merchants, and terminals not associated with the authorization message.

Responsive to the result, information about the authorization message may be transmitted to the payment system authorization platform at 5430. The information transmitted to the payment system authorization platform might comprise a supplemented authorization message. According to some embodiments, the supplemented authorization message includes at least one of: (i) a risk flag, (ii) a risk score, (iii) a cardholder category, (iv) a terminal category, and (v) enhanced Expert Monitoring Service (“EMS”) score data.

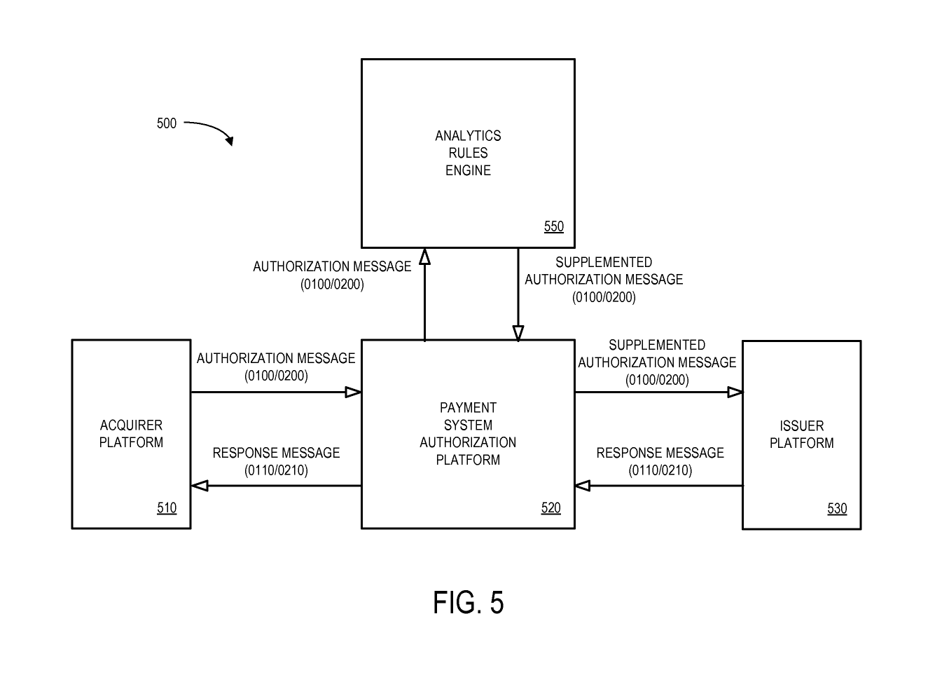

By way of example, consider FIG. 5 which illustrates an information flow 500 according to some embodiments. Initially, an acquirer platform 510 transmits an authorization message (e.g., an ISO 0100/0200 message) to a payment system authorization platform 520. The payment system authorization platform 520 forwards the authorization message to an analytics rules engine 550 which can analyze the message in accordance with one or more rules. For example, the analytics rules engine 550 may determine that transaction is associated with unusual cardholder or terminal activity. This information may be dropped into the authorization message and a supplemental authorization message may be transmitted to the payment system authorization platform 520. The payment system authorization platform 520 forwards the supplemental authorization message to the issuer platform 530 which can use the augmented and enhanced data to determine whether to accept or decline the transaction (e.g., via an ISO 0110/0210 message).

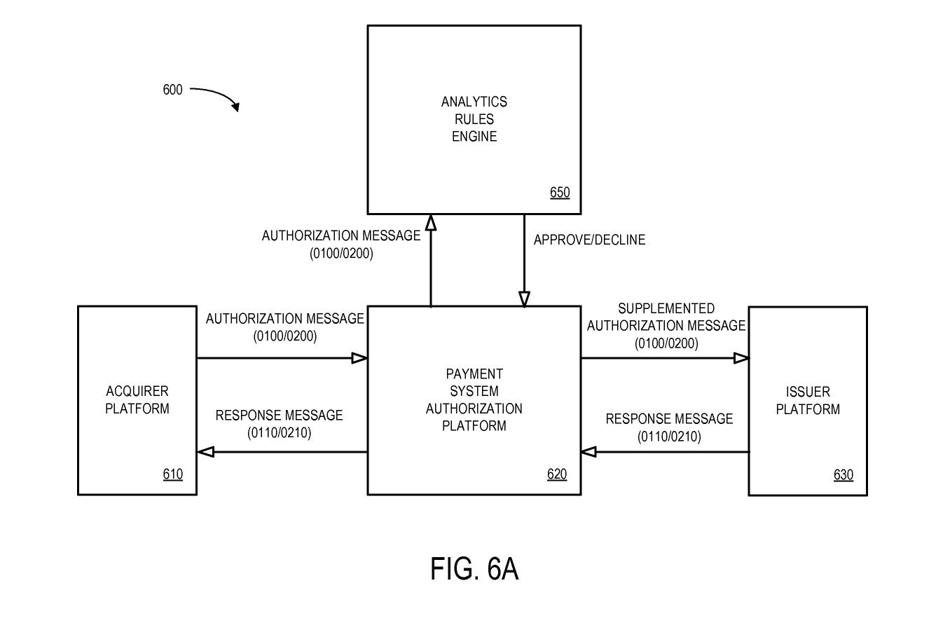

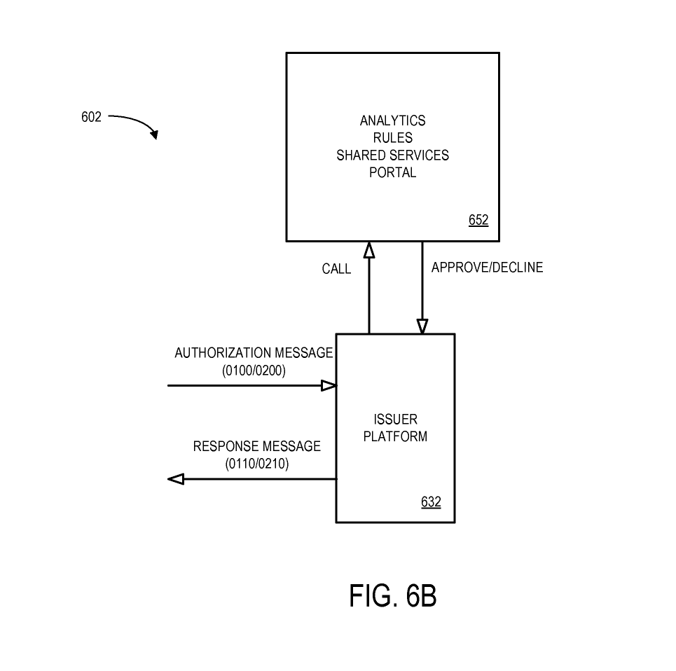

Instead of transmitting a supplemented authentication message to be used by the issuer platform 530, the analytics rules engine 550 might instead make an initial approval (or decline) decision. By way of example, consider FIG. 6A which illustrates an information flow 600 according to such an embodiment. As before, an acquirer platform 610 transmits an authorization message (e.g., an ISO 0100/0200 message) to a payment system authorization platform 620. The payment system authorization platform 620 forwards the authorization message to an analytics rules engine 650 which can analyze the message in accordance with one or more rules. For example, the analytics rules engine 650 may determine that a particular transaction is associated with unusual cardholder or terminal activity. This information may be used by the analytics engine 650 to decline the transaction (before the issuer platform 630 is involved). If the analytics rules engine 650 instead approves the transaction, the payment system authorization platform 620 forwards the (standard or supplemental) authorization message to the issuer platform 630 which can determine whether to accept or decline the transaction (e.g., via an ISO 0110/0210 message).

Consider a relatively high dollar, cross border, ecommerce authorization received from an electronics merchant via the acquirer platform 610. The payment system authorization platform 620 may route the authorization message to the analytics rules engine 650. The analytics rules engine 650 may perform a real-time lookup on the account to learn additional characteristic about the cardholder. In particular, it is determined that the cardholder never shops online. As a result the analytics rules engine declines the transaction. According to some embodiments further online authorizations are blocked for a pre-determined window of time (e.g., two hours).

As another example, consider FIG. 6B which illustrates an information flow 602 according to another embodiment. In this case, an issuer platform 632 calls an analytics rules shared services portal 652 which can analyze a transaction request in accordance with one or more rules. For example, the analytics rules shared services portals 652 may determine that transaction is associated with unusual merchant activity. This information may be used by the analytics rules shared services portal 652 to decline the transaction (without involving a payment system authorization platform). If the analytics rules shared services portal 652 instead provides a risk spectrum score, the issuer platform 632 may then use that scored to determine whether to accept or decline the transaction (e.g., via an ISO 0110/0210 message). According to some embodiments, the analytics rules shared services portal 652 may consider risk data built from sources outside of a particular authorization message. Moreover, the analytics rules shared services portal 652 may be associated with a fraud data mart that has access to fraud data rates for individual terminals and/or risk data determined based on information reported from other issuers.

Note that any of the analytics rules described herein may be associated with a wide variety of risk parameters. For example, cardholder and/or network level profiling may integrate data insights into real-time authorization and fraud strategies. Moreover, behavioral insight may be focused on merchant-level data that views activities across multiple payment card types. Examples of merchant-level profiling considerations include retail/spend categories (e.g., automobile fuel, bookstore purchases, subscription services, etc.) and spend category classifications (e.g., department stores, electric appliance stores, gasoline stations, mail order purchases, etc.). The analytics rules may also evaluate spending velocity parameters to look for transactions at an unusual volume at a particular time of day, unusual transaction amounts, and/or suspicious changes in approved and/or declined transaction volumes. According to some embodiments, historical rations may be used to allow for variances across merchant chants or specific locations.

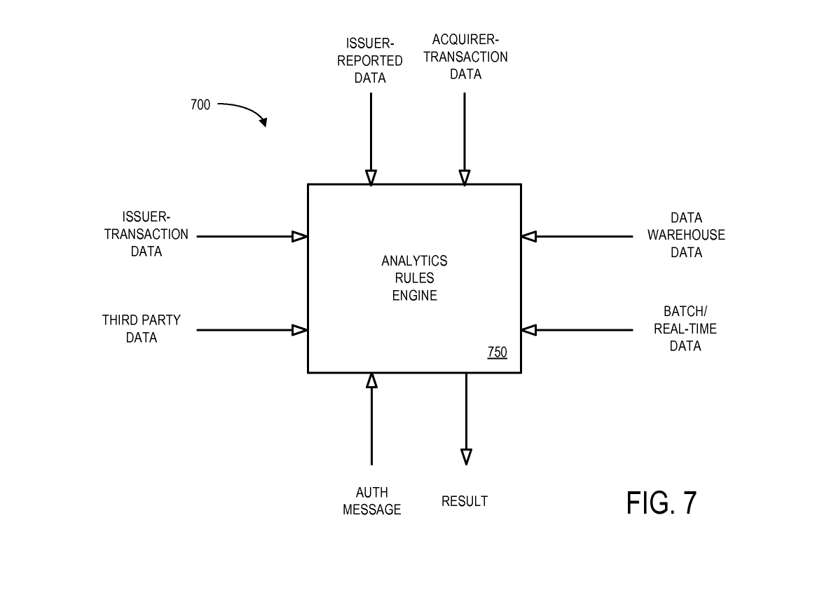

FIG. 7 illustrates an analytics rules engine 750 according to some embodiments that may receive and utilize third party data, issuer transaction data, issuer reported data, acquirer transaction data, data warehouse data, and/or batched or real time data (which might be associated with any brand, single & dual messages) to generate a result to be applied to behavioral segmentation, portfolio diagnostics, market and competitive insights, and/or loyalty and rewards programs according to some embodiments.

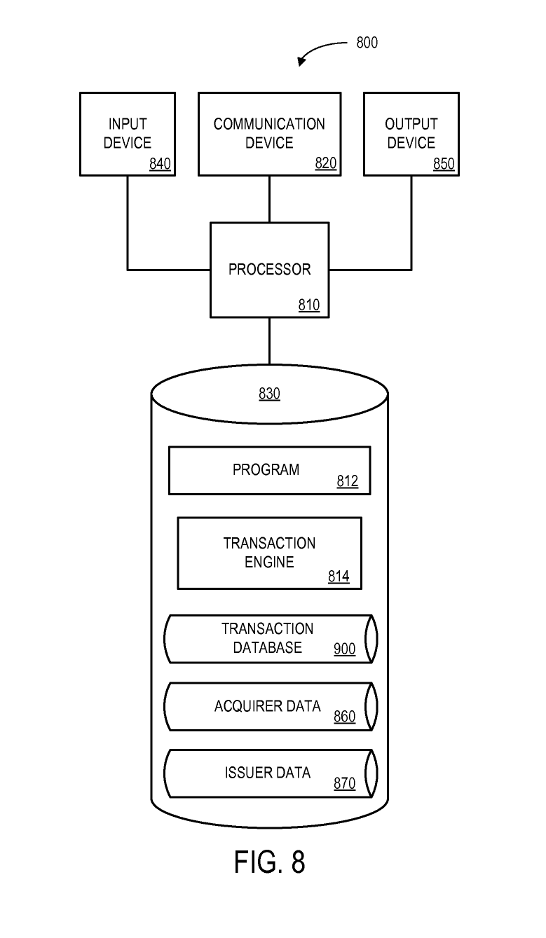

The embodiments described herein may be implemented using any number of different hardware configurations. For example, FIG. 8 illustrates a payment system authorization platform 800 that may be, for example, associated with the system 200 of FIG. 2. The payment system authorization platform 800 comprises a processor 810, such as one or more commercially available Central Processing Units (CPUs) in the form of one-chip microprocessors, coupled to a communication device 820 configured to communicate via a communication network (not shown in FIG. 8). The payment system authorization platform 800 further includes an input device 840 (e.g., a mouse and/or keyboard) and an output device 850 (e.g., a computer monitor).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 88 and/or a communications engine 814 (e.g., associated with a communications engine plug-in) for controlling the processor 810. The processor 810 performs instructions of the programs 812, 814, and thereby operates in accordance with any of the embodiments described herein. For example, the processor 810 may receive an authorization message from an acquirer platform. The processor 810 may determine that the authorization request meets a pre-determined condition and transmit information about the authorization message to an analytics rules engine, such as by transmitting the authorization message.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the payment system authorization platform 800 from another device; or (ii) a software application or module within the payment system authorization platform 800 from another software application, module, or any other source.

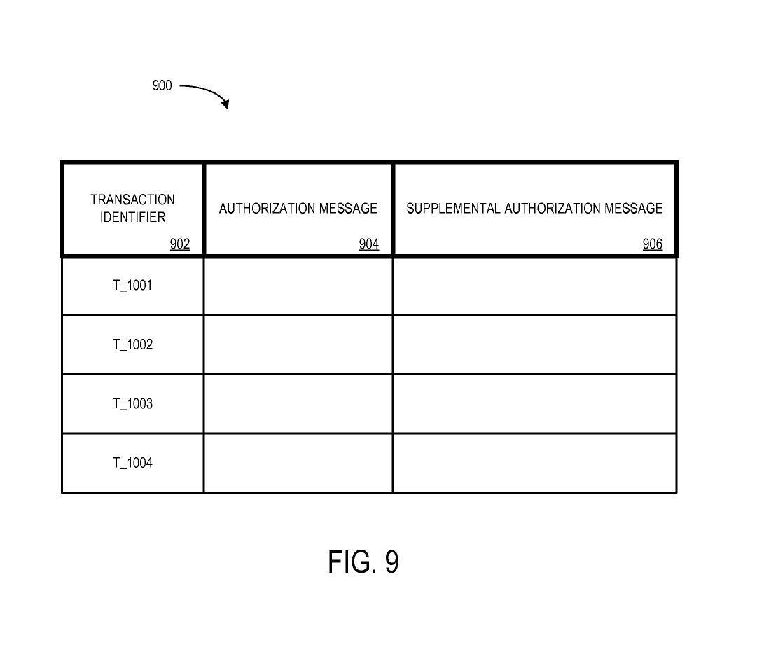

In some embodiments (such as shown in FIG. 8), the storage device 830 further stores a transaction database 900, acquirer data 860, and issuer data 870. An example of a database that may be used in connection with the payment system authorization platform 800 will now be described in detail with respect to FIG. 9. Note that the database described herein is only one example, and additional and/or different information may be stored therein. Moreover, various databases might be split or combined in accordance with any of the embodiments described herein.

Referring to FIG. 9, a table is shown that represents the transaction database 900 that may be stored at the payment system authorization platform 800 according to some embodiments. The table may include, for example, entries identifying payment card transaction. The table may also define fields 902, 904, 906 for each of the entries. The fields 902, 904, 906, may, according to some embodiments, specify: a transaction identifier 902, an authorization message 904, and a supplemented authorization message 906. The transaction database 900 may be created and updated, for example, based on information received from an acquirer platform and analytics rule engine.

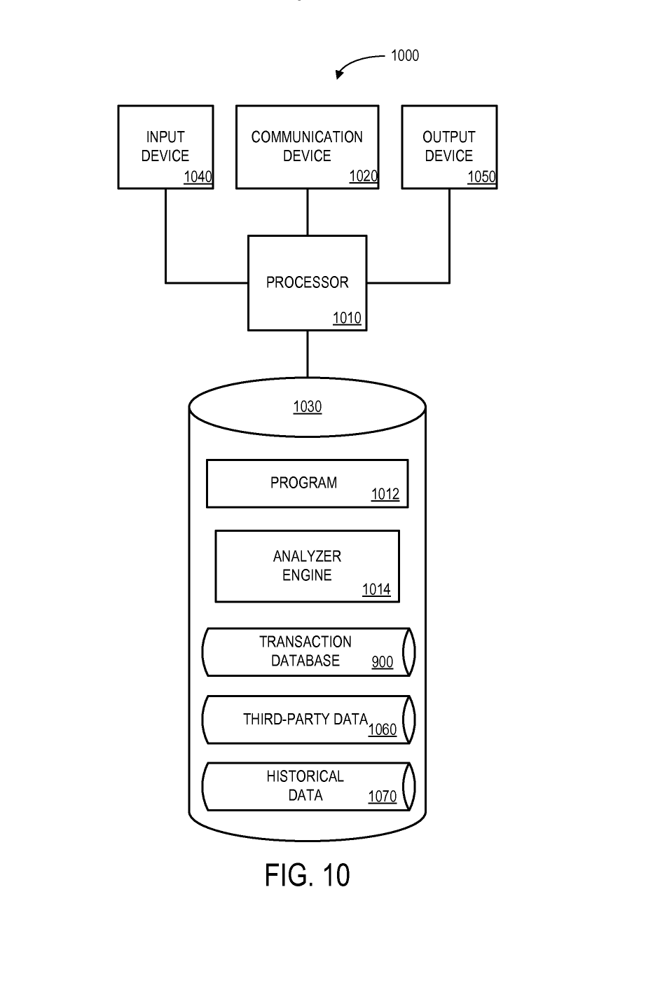

FIG. 10 illustrates an analytics rules engine 1000 that may be, for example, associated with the system 200 of FIG. 2. The analytics rules engine 1000 comprises a processor 1010, such as one or more commercially available Central Processing Units (CPUs) in the form of one-chip microprocessors, coupled to a communication device 1020 configured to communicate via a communication network (not shown in FIG. 10). The analytics rules engine 1000 further includes an input device 1040 (e.g., a mouse and/or keyboard) and an output device 1050 (e.g., a computer monitor).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or a communications engine 1014 (e.g., associated with a communications engine plug-in) for controlling the processor 1010. The processor 1010 performs instructions of the programs 1012, 1014, and thereby operates in accordance with any of the embodiments described herein. For example, the processor 1010 may analyze the information about the authorization message in accordance with at least one rule to generate a result and transmit information about the authorization message to a payment system authorization platform, such as by transmitting a supplemented authorization message or an authorization approval decision.

The programs 1010, 1014 may be stored in a compressed, uncompiled and/or encrypted format. The programs 1010, 1014 may furthermore include other program elements, such as an operating system, a database management system, and/or device drivers used by the processor 1010 to interface with peripheral devices.

As used herein, information may be “received” by or “transmitted” to, for example: (i) the analytics rules engine 1000 from another device; or (ii) a software application or module within the analytics rules engine 1000 from another software application, module, or any other source.

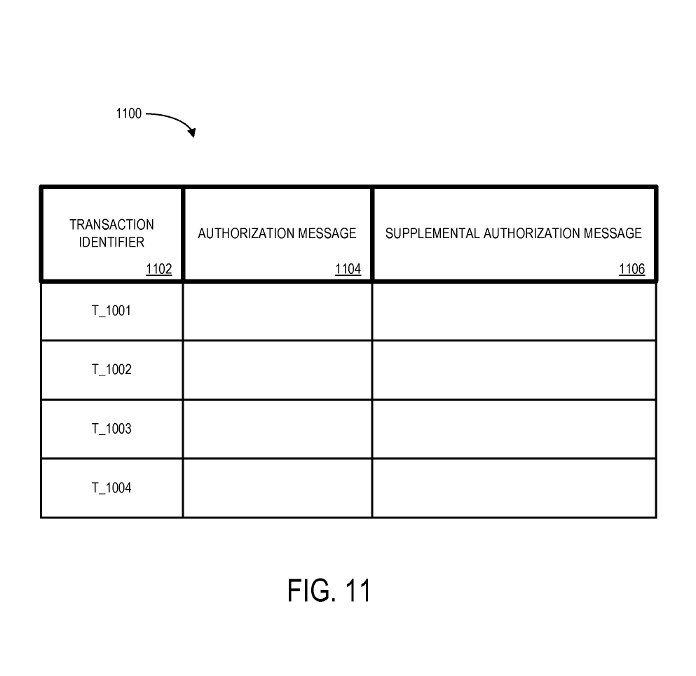

In some embodiments (such as shown in FIG. 10), the storage device 1030 further stores a transaction database 1100, third party data 1060, and historical data 1070. An example of a database that may be used in connection with the analytics rules engine 1000 will now be described in detail with respect to FIG. 11. Note that the database described herein is only one example, and additional and/or different information may be stored therein. Moreover, various databases might be split or combined in accordance with any of the embodiments described herein

Referring to FIG. 11, a table is shown that represents the transaction database 1100 that may be stored at the payment system authorization platform 800 according to some embodiments. The table may include, for example, entries identifying payment card transaction. The table may also define fields 1102, 1104, 1106 for each of the entries. The fields 1102, 1104, 1106 may, according to some embodiments, specify: a transaction identifier 1102, an authorization message 1104, and a supplemented authorization message 1106. The transaction database 1100 may be created and updated, for example, based on information received from an acquirer platform and analytics rule engine.

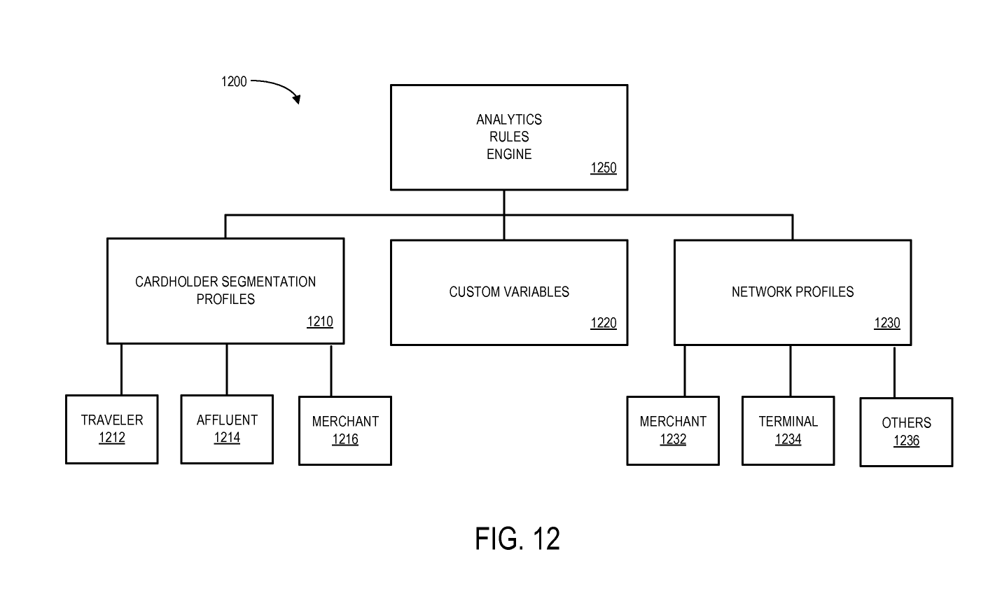

Any of the databases and/or analytic rules described herein may be used to integrate data insights into real-time authorization and/or fraud strategies. For example, FIG. 12 is a high level block diagram of a decision management profiling system 1200 according to some embodiments. An analytics rules engine 1250 may access cardholder segmentation profiles 1212, which may include traveler information 1212, affluent cardholder information 1214, merchant information 1216, and/or other data. Similarly, the analytics rules engine 1250 may access customer variable 1220 and network profiles 1230, such as merchant information 1232, terminal information, 1234, and/or other information 1236. In this way a fraud rule manager platform may leverage information to provide participating issuers with real-time supplemental data, within the online authorization, which can be consumed and interpreted by a receiving decisioning or rule platform to make more confident approval or decline decisions.

By providing issuers with real-time comparative data intelligence using both card-level data and POI terminal level data, issuers may have a broader set of contextual information to better identify when it's safe to approve transactions that may have otherwise been declined before due to insufficient information.

The data intelligence associated with the analytics rules engine 1250 may include card level data that a payment card system collects and analyzes, such as short and long term card spend activity on an issuer's portfolio, including, for example; geographic location, transaction type, spend category and amount level patterns, and cardholder validation methods (i.e., EMV versus PIN or magnetic stripe). According to some embodiments, some or all of this comparative data may be provided in an online authorization message.

The data intelligence associated with the analytics rules engine 1250 may also include network level data. For example, a payment card system may analyze global network information to provide real-time scores in an authorization message, including spend levels and patterns as well as recent fraud rates at POI terminals.

For issuer accounts ranges participating in an analytics rules service, the analytics rules engine 1250 may evaluate key data element values within a transaction and compares those data to the short and long term historical data points for that specific cardholder PAN and the particular terminal where the transaction is occurring. The results of those compares may be provided in the online message before forwarding it to the issuer or associated party.

According to some embodiments, the analytics rules engine 1250 may populate contextual data points into the online message in real-time for transactions processed by the service. Each data value populated in the message may be coded to indicate to a receiving decisioning system, for example, valuable information relevant to that particular authorization request and can provide the issuer an improved level of confidence to appropriately approve or decline the transaction.

The value from the analytics rules engine may be provided in a number of different ways. According to some embodiments, the data segment values themselves (e.g., cardholder category, merchant category, terminal category, etc.) may be presented to a party allowing them to use the data in any manner they choose. According to other embodiments, the data segment values may be utilized with other available data inputs to generate a confidence score. This confidence score might, for example, represent a range between 000 and 999, with the highest score values indicating a greater likelihood that the transaction is fraudulent and the lowest score values indicating a greater likelihood the transaction is genuine (i.e., not fraudulent).

Note that the delivery of these two data types (data segment values and confidence score value) may also occur in a number of different ways. According to some embodiments, the data is provided within the authorization request itself via specified data elements that are dedicated to the system. According to other embodiments, a web application programming interface call may be made to a shared services portal (which can respond with the appropriate data). Such a shared service portal approach may, for example, improve software development expenses and/or delivery timelines associated with processing new data fields from authorization messages.

Thus, embodiments may provide a real-time information analytics platform that may enable a card provider to operationalize traditional engagement-oriented insight-driven offerings (Advisors, rewards, etc.) into the authorization process—extending the value of these analytics-based services on a long-term, ongoing basis. Moreover, embodiments may leverage established Rules Engine platform knowledge to capture data from multiple internal and external sources (customer batch files, data warehouse, etc.) and analyze it in real-time according to customer-defined business rules. Moreover, customers may integrate their strategies for approvals, fraud prevention, marketing, retention and more into the real-time authorization process to take more informed action based on the customized rules they define for their business.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
receiving, at a payment system authorization platform, an authorization message from an acquirer platform;
determining, by the payment system authorization platform, that the authorization request meets a pre-determined condition;
responsive to the determination, transmitting information about the authorization message to an analytics rules engine; and
receiving, at the payment system authorization platform, information from the analytics rules engine.

2. The method of claim, wherein said transmitting comprises forwarding the authorization message to the analytics rules engine.

3. The method of claim 2, wherein the information received from the analytics rules engine is a supplemented authorization message.

4. The method of claim 13, wherein the supplemented authorization message includes at least one of: (i) a risk flag, (ii) a risk score, (iii) a cardholder category, (iv) a terminal category, and (v) enhanced expert monitoring service score data.

5. The method of claim 3, further comprising:
forwarding the supplemented authorization message to at least one of: (i) the acquirer platform, and (ii) an issuer platform.

6. The method of claim 1, wherein the information received from the analytics rules engine is an authorization approval decision.

7. The method of claim 6, further comprising:
responsive to the authorization approval decision, transmitting to an issuer platform at least one of (i) the authorization message, and (ii) a supplemented authorization message received from the analytics rules engine.

8. The method of claim 1, wherein the determination is based on a bank identification number associated with the authorization request.

9. A payment system authorization platform, comprising:
a first input to receive an authorization message from an acquirer platform;
a determination component to determine that the authorization request meets a pre-determined condition;
responsive to the determination, an output to transmit information about the authorization message to an analytics rules engine; and
a second input to receive information from the analytics rules engine.

10. A non-transitory, computer readable medium having stored therein instructions that, upon execution, cause a computer to perform a method, the method comprising:
receiving, at a payment system authorization platform, an authorization message from an acquirer platform;
determining, by the payment system authorization platform, that the authorization request meets a pre-determined condition;
responsive to the determination, transmitting information about the authorization message to an analytics rules engine; and
receiving, at the payment system authorization platform, information from the analytics rules engine.

11. A method, comprising:
receiving, at an analytics rules engine from a payment system authorization platform, information about an authorization message;
analyzing, by the analytics rules engine, the information about the authorization message in accordance with at least one rule to generate a result; and
responsive to the result, transmitting information about the authorization message to the payment system authorization platform.

12. The method of claim, wherein the received information comprises the authorization message.

13. The method of claim 12, wherein the information transmitted to the payment system authorization platform is a supplemented authorization message.

14. The method of claim 13, wherein the supplemented authorization message includes at least one of: (i) a risk flag, (ii) a risk score, (iii) a cardholder category, (iv) a terminal category, and (v) enhanced expert monitoring service score data.

15. The method of claim 11, wherein the information transmitted to the payment system authorization platform is an authorization approval decision.

16. The method of claim 11, wherein the rule is based on information about at least one of: (i) a cardholder associated with the authorization message, (ii) an account associated with the authorization message, (iii) a payment card associated with the authorization message, (iv) a merchant associated with the authorization message, and (v) a merchant terminal associated with the authorization message.

17. The method of claim 16, wherein the rule is based on at least one of: (i) a travel category, and (ii) an online spending category.

18. The method of claim 11, wherein the rule is based on information about a terminal associated with the authorization message.

19. The method of claim 18, wherein the rule is based on at least one of: (i) a transaction frequency, (ii) a transaction amount, and (iii) a transaction location.

20. The method of claim 11, wherein the rule is based on issuers other than an issuer associated with the authorization message.

21. The method of claim 11, wherein the rule is based on a cardholder other than a cardholder associated with the authorization message.

22. The method of claim 11, wherein the rule is based on a terminal other than a terminal associated with the authorization message.

23. An analytics rules engine, comprising:
an input to receive, from a payment system authorization platform, information about an authorization message;
an analyzer to analyze the information about the authorization message in accordance with at least one rule to generate a result; and
responsive to the result, an output to transmit information about the authorization message to the payment system authorization platform.

24. A non-transitory, computer readable medium having stored therein instructions that, upon execution, cause a computer to perform a method, the method comprising:
receiving, at an analytics rules engine from a payment system authorization platform, information about an authorization message;
analyzing, by the analytics rules engine, the information about the authorization message in accordance with at least one rule to generate a result; and
responsive to the result, transmitting information about the authorization message to the payment system authorization platform.

25. An analytics rules shared services portal, comprising:
an input to receive, from an issuer platform, a call associated with an authorization message;
an analyzer to analyze the information about the call in accordance with at least one rule to generate a result; and
responsive to the result, an output to transmit information about the authorization message to the issuer platform.

26. The analytics rules shared services portal of claim 25, wherein the at least one rule is associated with at least one of: (i) cardholder information, (ii) merchant information, and (iii) information associated with other issuer platforms.
